(19) United States
(12) Patent Application Publication
(10) Pub. No.: US 2018/0050229 A1
(43) Pub. Date: Feb. 22, 2018

(54) Real Time Damper Visual Verification Device and System

(71) Applicant: Gary Abernathy, Morganton, NC (US)

(72) Inventor: Gary Abernathy, Morganton, NC (US)

(21) Appl. No.: 15/678,423

(22) Filed: Aug. 16, 2017

Related U.S. Application Data
(60) Provisional application No. 62/375,629, filed on Aug. 16, 2016.

(51) Int. Cl. A62C 2/24; A62C 2/14; F24F 11/00; H04N 7/18; H04N 5/225

(52) U.S. Cl. CPC A62C 2/24; A62C 2/14; F24F 11/0086; H04N 2005/2255; H04N 5/2256; A62C 2/247; F24F 2011/0095; H04N 7/183

(57) ABSTRACT

A real-time damper visual verification device and system for use in combination with a HVAC duct structure includes a camera being structured and disposed for generating image signals in response to an optical image and the camera being in connection with a computer processor for generating the optical image and a real-time clock display; the camera being positioned for viewing the damper blades of the HVAC duct structure; wherein a verification procedure includes operating of the plurality of damper blades between first and second movements, the first movement defining the damper blades moving from an open position to a closed position and the second movement defining the damper blades moving from a closed position and an open position; and in which the camera records the optical images of the first and second movements to provide a true visual verification of operation of the damper blades between the first and second movements.

### RELATED APPLICATION

This application claims priority to and incorporates entirely by reference U.S. Provisional Patent Application Ser. No. 62/375,629 filed on Aug. 16, 2016.

### FIELD OF THE INVENTION

This invention relates to motorized smoke and fire/smoke dampers and, more particularly, to a device and system for providing visual verification in real time and documentation of motorized smoke and fire/smoke damper movement from fully open to fully closed positions and from fully closed to fully open positions.

### BACKGROUND OF THE INVENTION

Smoke dampers are passive fire protection products used in air conditioning and ventilation ductwork or installed in physical smoke barriers (e.g., walls). A combination of fans and dampers can exhaust smoke from an area while pressurizing the smoke-free areas around the affected area, thereby preventing the spread of smoke from the space of fire origin to other spaces in the same building. Smoke dampers need to be maintained, inspected and repaired to ensure they are in working order. The National Fire Protection Association (NFPA) requires the testing, maintenance and repair of smoke dampers as mandated in the Life Safety Code. NFPA 105 states that each damper shall be tested and inspected one year after installation. The test and inspection frequency shall then be every 4 years, except in hospitals, where the frequency shall be every 6 years. The code also states that the damper shall be actuated and cycled. The inspections must be document indicating the location of the damper, date of inspection, name of inspector, and deficiencies discovered.

Importantly, proper operation of motorized dampers installed at these damper locations is required by 2016 NFPA-80, Chapter 19 and 2016 NFPA-105, Chapter 7 to be visually confirmed and documented at the time of installation and at set intervals thereafter. HVAC ducts and dampers are routinely installed 5 to 25 feet above finished ceilings and can be rendered inaccessible through ceilings by surrounding ductwork, conduit, mechanical piping and structural members. Current efforts to address damper accessibility include; re-routing duct work, re-routing mechanical piping and erecting permanently installed ladders and platforms above ceilings, any of these approaches can be extremely expensive.

In an attempt to address the damper inaccessibility problem, U.S. Pat. Nos. 7,241,218 and 9,395,099 provided, from an Operator Work Station (OWS) wireless control, wireless communication and a Graphic User Interface (GUI). While U.S. Pat. No. 9,395,099 provides wireless access, wireless communication and remote monitoring and remote control, the patent depends on the physical state (opened or closed) of electrical contacts that are associated with position switches. A mechanical linkage that is affixed to a damper blade manipulates the position switches as the motorized damper moves. While the switches provide indication of two damper positions, open or closed, the system is not a visual confirmation as required by NFPA-105, Chapter 7, Paragraphs 7.6.3.3, (1), (3) and (5) for smoke dampers and NFPA-80, Chapter 19, Paragraphs 19.5.2.3.2, (1), (3) and (5) for fire dampers. Authorities having Jurisdiction (AHJ) such as the North Carolina State Construction Office and NC/DHHS/Health Services Regulation, the AHJ for healthcare facilities inspections ordered by the Center for Medicaid Services (CMS), do not recognize the use of position indicators switches as a means of true confirmation, because the method is not a visual confirmation.

In view of the problems discussed above, there exists a need for a low-cost system for providing remote, true, real time visual verification with simultaneous video recording of motorized smoke and fire/smoke damper movement from fully open to fully closed and from fully closed to fully open, and which may be in compliance with 2016 NFPA-80, Chapter 19 and 2016 NFPA-105, Chapter 7.

### SUMMARY OF THE INVENTION

In accordance with one form of the present invention, there is provided a real-time damper visual verification device and system for use in combination with a HVAC duct structure, the system including a camera being structured and disposed for generating image signals in response to an optical image and the camera being in connection with a computer processor for generating the optical image and a real-time clock display; the camera being positioned for viewing at least one of a plurality of damper blades of the HVAC duct structure; wherein the verification procedure includes operating of the plurality of damper blades between a first movement and a second movement, the first movement defining the plurality of damper blades moving from an open position to a closed position and the second movement defining the plurality of damper blades moving between a closed position and an open position; and in which the camera records the optical images of the first and second movements to provide a true visual verification of operation of the plurality of damper blades between the first and second movements.

The system and device for providing true real time visual means of remotely verifying and documenting motorized fire/smoke damper operation is required by The Life Safety Code NFPA-101 and subsequently NFPA-80 and NFPA-105. The system includes USB-connected or LAN (Ethernet)-connected miniature POE IP video cameras with integral LEDs for damper illumination. An endoscopic video camera or LAN-connected miniature POE IP camera is mechanically and permanently affixed to the interior of an HVAC duct at motorized damper locations and oriented to provide a clear view of the damper blades in some embodiments, the endoscopic video camera is connected to the USB port of a properly configured laptop computer or with appropriate USB adapters connected to a tablet, cell phone or other remote device.

In some embodiments, the LAN(Ethernet)-connected miniature POE IP camera is connected to a port of an existing office, campus, hospital or corporate Ethernet LAN switch through a POE Injector. Power to the POE Injector is connected through the normally open contacts of an IP controlled relay. The Ethernet port of the IP relay is connected to a second Ethernet port of the existing office, campus, hospital or corporate Ethernet LAN switch or alternately, through an RJ-45 Ethernet Splitter to share the same Ethernet port with the POE Injector. The IP relay functions to energize and de-energize the POE Injector and subsequently energizes and de-energizes the miniature POE IP video camera.

In accordance with one form of the present invention, the duct mounted endoscopic video camera is activated by executing an application installed on the computing device that is connected via USB to the endoscopic video camera. While the endoscopic video camera is operating and recording, an alarm is initiated in the Fire Alarm Control Panel (FACP) that controls the motorized damper undergoing the test/confirmation. As the damper blades move toward the closed position, the movement is recorded by the endoscopic video camera and simultaneously stored on the computing device that is connected to the endoscopic video camera. After the damper closing process has been recorded, the FACP is reset to normal. Consequently, the damper actuator is reenergized and the endoscopic video camera records the movement of the damper blades to the fully open position. The video recording of the entire cycle of the damper, fully open-to-fully closed and fully closed-to-fully open, is saved to an electronic video file with a date-time stamp. In some embodiments, the electronic video files are imported into a Computerized Maintenance Management (CMMS) software database and associated with building assets and/or barcodes and then used as exhibits to prove code compliance during random facilities surveys conducted by Joint Commissions Accreditation of Healthcare Organizations (JCAHO) and annual facilities surveys initiated by the Center for Medicaid Services (CMS).

In accordance with another form of the present invention, the duct mounted LAN(Ethernet)-connected miniature POE IP video camera is activated by typing the IP address of the IP relay into the internet address bar of a supported web browser. The IP relay is then energized through the browser based interface of the IP relay. After energizing the IP relay, the LAN(Ethernet) connected Miniature POE IP video camera is activated by typing the IP address of the LAN(Ethernet) connected Miniature POE IP video camera into the internet address bar of a supported web browser. While the LAN(Ethernet) connected Miniature POE IP video camera is operating and recording, an alarm is initiated in the Fire Alarm Control Panel (FACP) that controls the motorized damper undergoing the test/confirmation. As the damper blades move toward the closed position, the movement is recorded by the LAN(Ethernet) connected miniature POE IP video camera and simultaneously stored on the computing LAN connected computing device that is used to access the IP Relay and the LAN(Ethernet) connected POE IP Video camera browser based firmware. After the damper closing process has been recorded, the FACP is reset to normal. Consequently, the damper actuator is reenergized and the LAN(Ethernet) connected miniature POE IP video camera records the movement of the damper blades to the fully open position. The video recordings are saved with a date-time stamp in electronic file format on the computing device or to any comparable electronic media storage device. In some embodiments, the electronic video files are imported into a Computerized Maintenance Management (CMMS) software database and associated with building assets and/or barcodes and then used as exhibits to prove code compliance during random facilities surveys conducted by Joint Commissions Accreditation of Healthcare Organizations (JCAHO) and annual facilities surveys initiated by the Center for Medicaid Services (CMS).

### BRIEF DESCRIPTION OF THE DRAWINGS

For a fuller understanding of the nature of the present invention, reference should be made to the following detailed description, taken in conjunction with the accompanying drawings in which:

FIG. 1 is a perspective view, shown in partial cross section, of a permanently installed endoscopic video camera, motorized damper and HVAC duct general arrangement;

FIG. 2 is a perspective view, shown in partial cross section, illustrating a LAN(Ethernet)-connected miniature POE IP camera is connected to a port of an existing office, campus, hospital or corporate Ethernet LAN switch through a POE Injector, enabling camera access through any properly configured, LAN connected (wireless or hardwired) computer device; and

FIG. 3 illustrates the LAN(Ethernet)-connected Miniature POE IP Video Camera being accessed and controlled from a Local Area Network (LAN) connected remote computer.

Like reference numerals refer to like parts throughout the several views of the drawings.

### DETAILED DESCRIPTION OF THE PREFERRED EMBODIMENTS

Referring to the several views of the drawings, the real-time damper visual verification system of the present invention for use in combination with a HVAC duct 100 is shown and is generally indicated as 10.

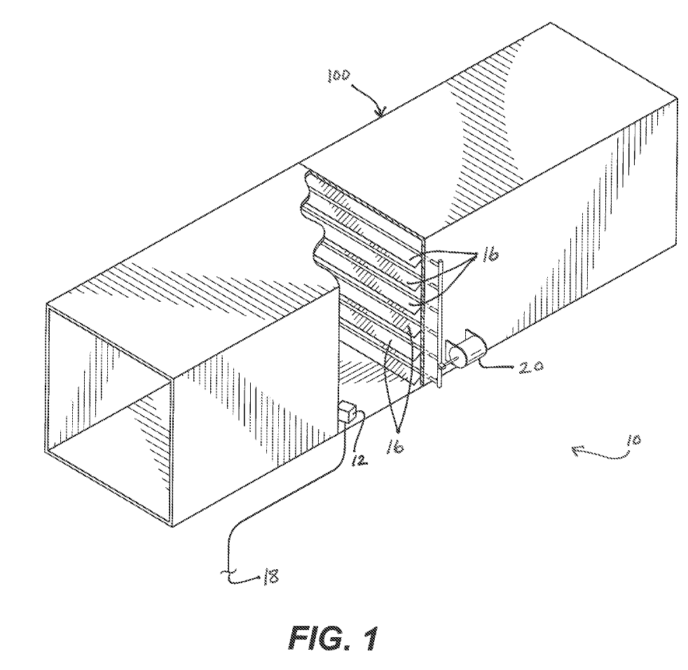

As shown in FIGS. 1-3, a device and system 10 for providing true real time visual means of remotely verifying and documenting motorized fire/smoke damper operation as required by The Life Safety Code NFPA-101 and subsequently NFPA-80 and NFPA-105 is provided. The system includes USB-connected or LAN (Ethernet)-connected miniature POE IP video cameras with integral LEDs for damper illumination. In one embodiment, an endoscopic video camera 12 or, in another embodiment of the system 10, a LAN-connected miniature POE IP camera 14, is mechanically and permanently affixed to the interior of an HVAC duct 100 at motorized damper locations and oriented to provide a clear view of the damper blades 16.

Referring specifically to FIG. 1, the endoscopic video camera 12 is connected to the USB port 18 of a properly configured laptop computer or, with appropriate USB adapters, connected to a tablet, cell phone or other comparable remote device. In operation, the duct mounted endoscopic video camera 12 is activated by executing an application installed on the computing device that is connected via USB to the endoscopic video camera 12. While the endoscopic video camera 12 is operating and recording, an alarm is initiated in the Fire Alarm Control Panel (FACP) that controls the motorized damper undergoing the test/confirmation. As the damper blades 16 move to the closed position by the damper actuator 18, the movement is recorded by the endoscopic video camera 12 and simultaneously stored on the computing device that is connected to the endoscopic video camera 12.

After the damper closing process has been recorded, the FACP is reset to normal. Consequently, the damper actuator 18 is reenergized and the endoscopic video camera 12 records the movement of the damper blades 16 to the fully open position. The video recording of the entire cycle of the damper blades 16 (fully open to fully closed and fully closed to fully open) is saved to an electronic video file with a date-time stamp 32. In some embodiments, the electronic video files are imported into a Computerized Maintenance Management (CMMS) software database and associated with building assets and/or barcodes and then used as exhibits to prove code compliance during random facilities surveys conducted by Joint Commissions Accreditation of Healthcare Organizations (JCAHO) and annual facilities surveys initiated by the Center for Medicaid Services (CMS).

Referring still to FIG. 1, the USB male connector of the cable component of the endoscopic video camera 12 can be, as an option, terminated within a wall-mounted, single gang electrical box and a USB Wall Plate. In one embodiment, the endoscopic video camera 12 can be activated and video remotely recorded from a Local Area Network (LAN) connected computer workstation by connecting the endoscopic video camera USB cable through a Power Over Ethernet (POE) adapter (e.g. SII USB over IP—Device Server).

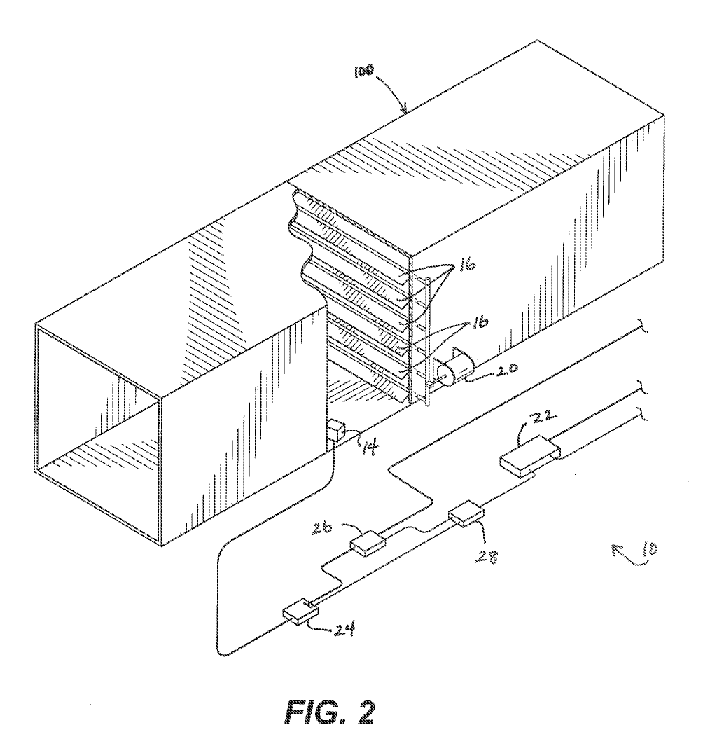

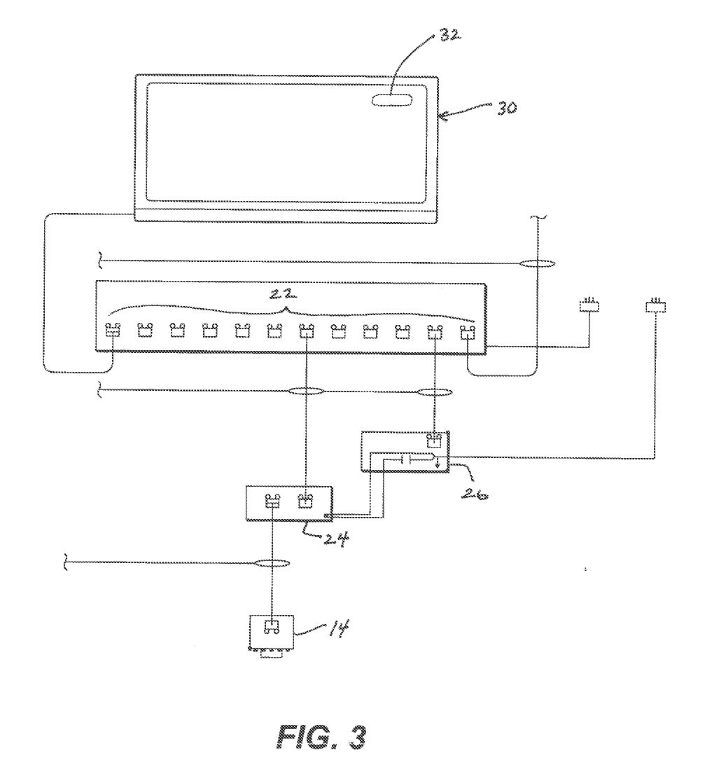

Referring now to FIG. 2, the LAN(Ethernet)-connected miniature POE IP camera 14 is connected to a port of an existing office, campus, hospital or corporate Ethernet LAN switch 22 through a POE Injector 24. Power to the POE Injector 24 is connected through the normally open contacts of an IP controlled relay 26. The Ethernet port of the IP relay is connected to a second Ethernet port of the existing office, campus, hospital or corporate Ethernet LAN switch or alternately, through an RJ-45 Ethernet Splitter 28, as presently shown, to share the same Ethernet port with the POE Injector 24. The IP relay 26 functions to energize and de-energize the POE Injector 24 and subsequently energizes and de-energizes the miniature POE IP video camera 14. In operation, the duct mounted LAN(Ethernet)-connected miniature POE IP video camera 14 is activated by typing the IP address of the IP relay 26 into the internet address bar of a supported web browser. The IP relay 26 is then energized through the browser based interface of the IP relay 26. After energizing the IP relay 26, the LAN(Ethernet)-connected Miniature POE IP video camera 14 is activated by typing the IP address of the LAN(Ethernet) connected Miniature POE IP video camera 14 into the internet address bar of a supported web browser. While the LAN(Ethernet) connected Miniature POE IP video camera 14 is operating and recording, an alarm is initiated in the Fire Alarm Control Panel (FACP) that controls the motorized damper undergoing the test/confirmation. As the damper blades 16 move toward the closed position, the movement is recorded by the LAN(Ethernet)-connected miniature POE IP video camera 14 and simultaneously stored on the computing LAN connected computing device 30 (see FIG. 3) that is used to access the IP relay and the LAN(Ethernet)-connected POE IP Video camera browser based firmware.

After the damper closing process has been recorded, the FACP is reset to normal. Consequently, the damper actuator 20 is reenergized and the LAN(Ethernet)-connected miniature POE IP video camera 14 records the movement of the damper blades 16 to the fully open position. The video recordings are saved with a date-time stamp 32 in electronic file format on the computing device 30 or to any comparable electronic media storage device. In some embodiments, the electronic video files are imported into a Computerized Maintenance Management (CMMS) software database and associated with building assets and/or barcodes and then used as exhibits to prove code compliance during random facilities surveys conducted by Joint Commissions Accreditation of Healthcare Organizations (JCAHO) and annual facilities surveys initiated by the Center for Medicaid Services (CMS).

Referring now to FIG. 3, the LAN(Ethernet)-connected miniature POE IP video camera 14 being accessed and controlled from a Local Area Network (LAN)-connected remote computer 30. The IP (Internet Protocol) controlled relay 26 serves to energize and de-energize the POE (Power Over Ethernet) injector power and subsequently energizes and de-energizes the duct-mounted miniature POE IP video camera 14. The logical state of the IP relay's 26 electrical contacts is manually set (closed-open/off-on) through the IP relay's 26 browser-based user interface. Typing the IP relay's 26 IP address in the IP address bar of the browser being used accesses the IP relay's 26 browser-based user interface. The POE (Power Over Ethernet) injector 24 provides power to the remotely located, duct-mounted IP miniature video camera 14 through the Cat5/Cat6 Ethernet data cable. Conductor color pairs normally used for POE injection are (blue & white/blue) or (white/brown & brown), pin numbers (4&5 or 7&8), respectively of an RJ-45 Ethernet connector. The POE 24 is powered on and off by the logical state of the IP relay 26, as described above, which subsequently energizes and de-energizes the remote, duct-mounted miniature IP POE video camera 14. The Miniature IP (Internet Protocol) POE camera 14 may include integral LEDs (Light Emitting Diodes) for damper illumination. The video camera 14 is permanently installed inside the HVAC duct 100 and focused to view all dampers blades 16. After being powered on through the IP relay (as described above), the video recording, is controlled (on/off) through the video camera's software, which is installed on the computing device 30 used to access the duct-mounted video camera 14. The video incudes a software imposed date/time stamp 32. Camera video recordings are saved to a user selected electronic file storage device for future retrieval during legislatively required inspections.

In one embodiment, the endoscopic video camera 12 is permanently mounted inside the HVAC duct 100. In one embodiment, the endoscopic video camera 12 incorporates integral light emitting diodes (LEDs) to provide damper illumination for video recording. In one embodiment, the endoscopic video camera 12 is connected to a USB port of a laptop computer or with the appropriate adapter, connected to a tablet, a handheld/PDA, cell phone, or other electronic device having a visual display. In one embodiment, the endoscopic video camera USB cable is 3 meters or greater in length. In one embodiment, the endoscopic video camera USB cable can be extended using an active USB extension cable. In one embodiment, the endoscopic video camera 12 is in wireless communication with the electronic device.

While the device and system 10 has thus far been described for use in combination with motorized dampers 16 deployed for fire safety, it should be understood that application of the device and system 10 described herein may be used in combination with any motorized damper system 16. Moreover, the device and system 10 may be offered as an add option to newly manufactured motorized dampers 16 or, alternatively, as a field-installed accessory kit to be installed with previously installed, operating motorized dampers 16.

While the present invention has been shown and described in accordance with several preferred and practical embodiments, it is recognized that departures from the instant disclosure are contemplated within the spirit and scope of the present invention.

What is claimed is:

1. A real-time damper visual verification device and system for use in combination with a HVAC duct structure, said system comprising:
a camera being structured and disposed for generating image signals in response to an optical image and said camera being in connection with a computer processor for generating the optical image and a real-time clock display;
said camera being positioned for viewing at least one of a plurality of damper blades of the HVAC duct structure;
wherein a verification procedure includes operating of the plurality of damper blades between a first movement and a second movement, the first movement defining the plurality of damper blades moving from an open position to a closed position and the second movement defining the plurality of damper blades moving from a closed position and an open position;
in which said camera records the optical images of the first and second movements to provide a true visual verification of operation of the plurality of damper blades between the first and second movements.

2. The system as recited in claim 1 wherein said camera is an endoscopic video camera.

3. The system as recited in claim 1 wherein said camera is a LAN(Ethernet)-connected miniature POE IP video camera; and said system further comprising at least one server and a network capable of connecting to the server.

4. The system as recited in claim 1 wherein said camera is mounted to an inner facing surface of the HVAC duct structure.

5. The system as recited in claim 1 further comprising at least one integrated LED element on said camera for providing illumination during recording of the operation of the damper blades.

6. The system as recited in claim 2 wherein said computer processor is a portable computer processor and said endoscopic video camera is connected to a port of the portable computer processor.

7. The system as recited in claim 6 wherein the male connector of the cable component of said endoscopic video camera is terminated within a wall-mounted, single gang electrical box and a wall plate.

8. The system as recited in claim 3 wherein said LAN(Ethernet)-connected miniature POE IP video camera is activated and video remotely recorded from a Local Area Network (LAN) connected computer workstation by connecting the LAN(Ethernet)-connected miniature POE IP video camera through a Power Over Ethernet (POE) adapter.

9. The system as recited in claim 8 wherein said LAN(Ethernet)-connected miniature POE IP video camera is remotely powered on and off using an IP controlled relay.

10. The system as recited in claim 8 wherein said LAN(Ethernet)-connected miniature POE IP video camera is remotely powered by a POE injector.

11. The system as recited in claim 1 wherein recordings are imported into a database to be associated with the plurality of dampers, each having a barcode/asset identification for the purpose of proving code required damper tests during random facility inspections.
